(19) United States
(12) Patent Application Publication
(10) Pub. No.: US 2004/0069182 A1
(43) Pub. Date: Apr. 15, 2004

(54) UV ray curable ink and image formation mehtod

(75) Inventor: Atsushi Nakajima, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Corporation, Tokyo (JP)

(21) Appl. No.: 10/673,102

(22) Filed: Sep. 26, 2003

(30) Foreign Application Priority Data
Oct. 10, 2002 (JP) JP2002-297347

(51) Int. Cl. C09D 11/00

(52) U.S. Cl. 106/31.13

(57) ABSTRACT

Disclosed is a UV ray curable ink comprising pigment, a polymerizable compound, and a photopolymerization initiator, wherein the UV ray curable ink has an absolute value of a viscosity difference between a viscosity at 25° C. at shear rate 10 (1/s) and a viscosity at 25° C. at shear rate 1000 (1/s) being not more than 5 mPa·s, and has a surface tension at 25° C. of from 26 to 38 mN/m.

### FIELD OF THE INVENTION

The present invention relates to ultraviolet ray (UV) curable ink for ink jet recording, and an image formation method employing the ink.

### BACKGROUND OF THE INVENTION

In recent years, an ink jet recording method has been developed which ejects UV curable ink onto a paper recording material and cures the ink employing UV rays, and put into practical use. Examples of the ink include those disclosed in WO 99/29787, WO 99/29788, WO 97/31071, and Japanese Patent O.P.I. Publication Nos. 5-214280 and 2002-188025.

There is a disclosure in for example, WO 99/29787 that as the ink characteristics, viscosity of the ink is preferably not more than 35 mPa·s at 30° C. This shows a condition suitable for ink ejecting in the ink jet recording method. In the literatures described above is also disclosed an ink composition meeting this condition as far as ink is concerned.

The ink jet recording method employing UV curable ink has the advantage that can record on non-absorptive recording material (which does not absorb ink), while has problem in that a reactive diluent (such as a polymerizable monomer or oligomer) remains on a recording material without evaporating or shrinking to form embossed images, resulting in lowering of image quality.

In order to solve the above problem, the present inventor has made a study on a method which ejects ink droplets with a minute size and appropriately levels the ink droplets to obtain an image with high quality. Various nozzles or driving methods are known which obtain ink droplets with a minute size.

However, it has been found that it is difficult to eject minute droplets of UV curable ink with high stability and high accuracy, since the UV curable ink has a high viscosity as compared with water based ink. Particularly when ejecting ink droplets having a volume of less than 10 pl, employing a gray scale type head which can change the droplet size, it is difficult to continuously eject a conventional ink with high stability and deposit it onto recording material with high accuracy.

### SUMMARY OF THE INVENTION

An object of the invention is to provide UV ray curable ink which is capable of being ejected with high stability to achieve accurate ink deposition onto recording material, and to provide an image formation method forming an image with high precision employing the UV ray curable ink.

### DETAILED DESCRIPTION OF THE INVENTION

The above object has been achieved by the following constitutions.

1. A UV ray curable ink comprising pigment, a polymerizable compound, and a photopolymerization initiator, wherein the UV ray curable ink has an absolute value of a viscosity difference between a viscosity at 25° C. at shear rate 10 (1/s) and a viscosity at 25° C. at shear rate 1000 (1/s) being not more than 5 mPa·s, and has a surface tension at 25° C. of from 26 to 38 mN/m.

2. The UV ray curable ink of item 1 above, wherein the absolute value of a viscosity difference in viscosity at 25° C. at shear rate 10 (1/s) between the ink and the polymerizable compound is not more than 10 mPa·s.

3. The UV ray curable ink of item 1 above, wherein the absolute value of a viscosity difference between a viscosity at 25° C. at shear rate 10 (1/s) and a viscosity at 25° C. at shear rate 1000 (1/s) is not more than 2 mPa·s.

4. The UV ray curable ink of item 1 above, wherein the surface tension at 25° C. is from 28 to 35 mN/m.

5. The UV ray curable ink of item 2 above, wherein the absolute value of a viscosity difference in viscosity at 25° C. at shear rate 10 (1/s) between the ink and the polymerizable compound is not more than 5 mPa·s.

6. The UV ray curable ink of item 1 above, wherein the polymerizable compound is a cation polymerizable compound.

7. The UV ray curable ink of item 6 above, wherein the cation polymerizable compound is comprised of an oxetane compound and at least one of an epoxy compound and a vinyl ether compound.

8. The UV ray curable ink of item 7 above, wherein the oxetane compound has from one to four oxetane rings in the molecule.

9. The UV ray curable ink of item 8 above, wherein the oxetane compound having one oxetane ring in the molecule is a compound represented by the following formula 1,

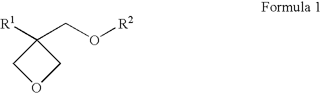

wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; and R² represents an alkyl group having from 1 to 6 carbon atoms, an alkenyl group having from 2 to 6 carbon atoms, an aromatic ring-containing group, an alkylcarbonyl group having from 2 to 6 carbon atoms, an alkoxycarbonyl group having from 2 to 6 carbon carbons, or an N-alkylcarbamoyl group having from 2 to 6 carbon atoms.

10. The UV ray curable ink of item 8 above, wherein the oxetane compound having two oxetane rings in the molecule is a compound represented by the following formula 2,

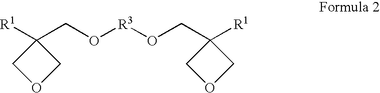

wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; and R³ represents a straight chained or branched alkylene group, a straight chained or branched polyalkyleneoxy group, a straight chained or branched divalent unsaturated hydrocarbon group, an alkylene group containing a carbonyl group, an alkylene group containing a carbonyloxy group, or an alkylene group containing a carbamoyl group.

11. The UV ray curable ink of item 8 above, wherein the oxetane compound having two oxetane rings in the molecule is a compound represented by the following formula 7,

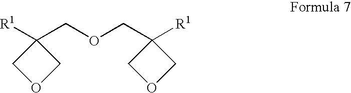

wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group.

12. The UV ray curable ink of item 8 above, wherein the oxetane compound having tree or four oxetane rings in the molecule is a compound represented by the following formula 8,

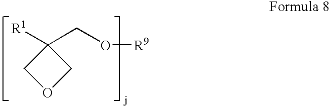

wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; R⁹ represents a branched alkylene group having 1 to 12 carbon atoms, a branched polyalkyleneoxy group, or a branched alkylene group containing a silylether group; and j represents an integer of 3 or 4.

13. The UV ray curable ink of item 8 above, wherein the oxetane compound having from one to four oxetane rings in the molecule is a compound represented by the following formula 9,

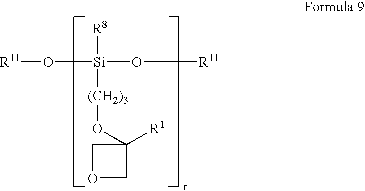

wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; R⁸ represents an alkyl group having from 1 to 4 carbon atoms or an aryl group; R¹¹ represents an alkyl group having 1 to 4 carbon atoms or a trialkylsilyl group; and r represents an integer of from 1 to 4. 14. The UV ray curable ink of item 6 above, wherein the cation polymerizable compound content of the ink is from 1 to 97% by weight based on the weight of the ink.

15. The UV ray curable ink of item 14 above, wherein the cation polymerizable compound content of the ink is from 30 to 95% by weight based on the weight of the ink.

16. The UV ray curable ink of item 1 above, wherein the polymerizable compound is a radical polymerizable compound.

17. The UV ray curable ink of item 16 above, wherein the radical polymerizable compound content of the ink is from 1 to 97% by weight based on the weight of the ink.

18. The UV ray curable ink of item 17 above, wherein the radical polymerizable compound content of the ink is from 30 to 95% by weight based on the weight of the ink.

19. An image formation method comprising the steps of ejecting the UV ray curable ink of item 1 above as ink droplets onto recording material, employing on-demand type ink jet nozzles, and irradiating UV rays to the ink ejected on the recording material to form an image, wherein the ink droplets comprise two or more separate ink droplets with a different volume.

20. The image formation method of item 19 above, wherein the minimum volume of the ink droplets is less than 10 pl.

2-1. A UV ray curable ink comprising pigment, a polymerizable compound, and a photopolymerization initiator, wherein the UV ray curable ink has a difference between a viscosity at 25° C. at shear rate 10 (1/s) and a viscosity at 25° C. at shear rate 1000 (1/s) being not more than 5 mPa·s, and has a surface tension at 25° C. of from 26 to 38 mN/m.

2-2. The UV ray curable ink of item 2-1 above, wherein the difference in viscosity at 25° C. at shear rate 10 (1/s) between the ink and the polymerizable compound is not more than 10 mPa·s. 2-3. The UV ray curable ink of item 2-1 or 2-2 above, wherein the polymerizable compound is a cation polymerizable monomer.

2-4. An image formation method comprising the steps of ejecting the UV ray curable ink of any one of items 2-1 through 2-3 above as ink droplets onto recording material, employing on-demand type ink jet nozzles, and irradiating UV rays to the ink ejected on the recording material to form an image, wherein the ink droplets comprise two or more ink droplets with a different volume.

2-5. The image formation method of item 2-4 above, wherein the minimum volume of the ink droplets is less than 10 pl.

Next, the present invention will be explained.

Generally, the ultraviolet ray (UV) curable ink for ink jet recording contains pigment as a colorant. This is because the pigment is not only excellent in weather resistance but advantageous in that reaction is not inhibited, as compared with a dye. However, it is relatively difficult to disperse pigment into small size in a monomer or oligomer as a UV curable compound to give a low viscosity.

Viscosity of the ink greatly varies due to measuring conditions, and greatly depends upon shear rate of the ink as well as temperature of the ink. The shear rate of the ink is extremely high, since it is driven in a narrow orifice at high frequency. It is generally difficult to measure the ink viscosity under the same condition as ejected from an ink jet recording head, but it is preferred that the viscosity is measured under the possible highest shear rate.

However, as a result of study, it has been found that ink viscosity under a low shear rate is also very important in view of stable ink ejection. Because ink while ink flows in the ink flow path, a high shear is not necessarily applied to the ink. When ink has a great thixotropic property, pseidoplasticity, or flowability, the ink viscosity is extremely high under a low shear rate. In this case, when ink dwells in the ink path with no shear applied or a recording head is not driven for a long time,

An ink jet recording head employs plural ink droplets having different sizes, minute ink droplets, and plural nozzles in order to form an image with high precision. In such an ink jet recording head, difference in ink fluidity is likely to affect ink ejection stability or ink ejection accuracy.

So far, there have been no literatures referring to the relationship between ink viscosity and shear rate in UV curable inks.

The UV ray curable ink of the invention comprises pigment, a polymerizable compound, and a photopolymerization initiator, wherein the UV ray curable ink has an absolute value of a viscosity difference between a viscosity at 25° C. at shear rate 10 (1/s) and a viscosity at 25° C. at shear rate 1000 (1/s) being not more than 5 mPa·s, and has a surface tension at 25° C. of from 26 to 38 mN/m.

The present inventor has found that ink having an absolute value of a viscosity difference (hereinafter also referred to as simply a viscosity difference) between a viscosity at 25° C. at Shear rate 10 (1/s) and a viscosity at 25° C. at Shear rate 1000 (1/s) being not more than 5 mPa·s can reduce viscosity difference of ink in ink channels, prevent ink dwell, and provide stability of ink ejection velocity and accurate ink deposition onto recording material. The viscosity difference exceeding 5 mPa·s causes ink deterioration (aggregation or clogging) in ink dwell portions, or lowers initial ink ejection velocity, resulting in fluctuation of ink droplet ejection velocity, and curved ejection of ink during long-term continuous ink ejection. The viscosity difference is preferably not more than 5 mPa·s, and more preferably zero. The less the viscosity difference is, the better.

The present inventor has found that the ink further having a surface tension at 25° C. of from 26 to 38 mN/m can provide a color image with high quality, formed by color superposition. Ink having a surface tension of less than 26 provides a reduced surface energy of the cured ink, wherein the superposed ink droplets on recording material do not sufficiently spread, resulting in formation of small dots. In contrast, ink having a surface tension exceeding 38 forms too large dots, resulting in bleeding of the dots. The surface tension is preferably from 28 to 35 mN/m.

In the invention, pigment is dispersed in a polymerizable compound as a dispersion medium. However, when the difference in viscosity between the dispersion medium and ink obtained after dispersion is large, it is not desirable, since the ink has a thixotropic property, resulting in viscosity increase at a low shear or in lowering of storage stability. In the invention, an absolute value of a viscosity difference (hereinafter also referred to as simply a viscosity difference) at 25° C. at shear rate 10 (1/s) between the dispersion medium and ink obtained after dispersion is preferably not more than 10 mPa·s, more preferably not more than 5 mPa·s, and most preferably zero. The smaller the difference is, the better.

When the ink contains a solvent in addition to the polymerizable compound as a dispersion medium, the dispersion medium is a mixture of the solvent and the polymerizable compound, and the absolute value of a viscosity difference at 25° C. at shear rate 10 (1/s) between the mixture and ink obtained after dispersion is preferably not more than 10 mPa·s, more preferably not more than 5 mPa·s, and most preferably zero.

Ink containing a cation polymerizable compound is preferred as compared with ink containing a radical polymerizable compound, since it can provide high sensitivity. Polymerization of the former ink is not inhibited due to oxygen, which is problematic for that of the latter ink.

The ink containing a cation polymerizable compound is preferred, since polymerization is greatly inhibited due to oxygen, particularly when the ink droplet volume of the ink containing a radical polymerizable compound is small, for example, less than 10 pl.

Ink having such a viscoelasticity as defined in the invention (item 1 or 2 above), particularly when plural ink droplets having a different size are ejected and deposited on recording material, can provide improved ejection stability of each droplet and accuracy of the ink deposition. The reason is considered that the different size of the ink droplets changes a shear rate applied.

Ink droplets having a volume less than 10 pl applies a high shear to the ink, and as the difference between ink viscosity having when ink recording head is driven and ink viscosity having when ink recording head is not driven is smaller, ink ejection stability is more excellent.

The polymerizable compounds used in the invention include a radical polymerizable compound and a cation polymerizable compound. Examples of the radical polymerizable compound include those disclosed in Japanese Patent O.P.I. Publication Nos. 7-159983, 8-224982, and 10-863 and Japanese Patent Publication No. 7-31399, and examples of the cation polymerizable compound include various known cation polymerizable monomers, for example, epoxy compounds, vinyl ethers, or oxetane compounds disclosed in Japanese Patent O.P.I. Publication Nos. 6-9714, 2001-3189,2, 2001-40068, 2001-55507, 2001-310938, 2001-310937, and 2001-220526.

The radical polymerizable compound is an ethylenically unsaturated compound capable of being polymerized by a radical, and is any compound, as long as it has at least one ethylenically unsaturated double bond in the molecule. The radically polymerizable compound may have any structure in the form of monomer, oligomer or polymer. The radical polymerizable compounds can be used singly or as a mixture of two or more kinds thereof at any content ratio, according to the objects of the usage.

The ethylenically unsaturated compounds, capable of being polymerized by a radical, include an unsaturated carboxylic acid such as acrylic acid, methacrylic acid, itaconic acid, crotonic acid, isocrotonic acid, or maleic acid or its salt; ester; urethane; amide or anhydride; acrylonitrile; styrene; unsaturated polyesters; unsaturated polyethers; unsaturated polyamides; and unsaturated polyurethanes. Examples thereof include an acrylic acid derivative such as 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxypolyethoxyphenyl)propane, neopentyl glycol diacrylate, 1,6-hexanediol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, oligo ester acrylate, N-methylol acryl amide, diacetone acryl amide, or epoxy acrylate; a methacrylic acid derivative such as methyl methacrylate, n-butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, ethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, or 2,2-bis (4-methacryloxy-polyethoxyphenyl)propane; an allyl compound such as alltl glycidyl ether, diallyl phthalate or triallyl trimellitate; and radical polymerizable or crosslinkable monomers, oligomers or polymers described in S. Yamashita et al., “Crosslinking agent Handbook”, Taisei Co., Ltd. (1981), K. Kato et al., “UV, EB Hardenable Handbook (Materials)”, Kobunshi Kankokai (1985), Radotek Kenkyukai, “UV, EB Hardening Technology, Application and Market”, pp. 79, CMC Co. Ltd. (1989), and E. Takiyama, “Polyester Resin Handbook”, Nikkan Kyogyo Shinbunsha (1988).

The content of the radical polymerizable compound in ink is preferably from 1 to 97% by weight, and more preferably from 30 to 95% by weight.

In the invention, the UV ray curable ink preferably contains, as a cation polymerizable compound, an oxetane compound and at least one of an epoxy compound and a vinyl ether compound.

The epoxy compounds include an aromatic epoxide, an alicyclic epoxide, and an aliphatic epoxide.

A preferable aromatic epoxide, is a di- or poly-glycidyl ether manufactured by a reaction of polyhydric phenol having at least one aromatic ring or of an alkylene oxide adduct thereof with epichlorohydrin, and includes, for example, such as di- or poly-glycidyl ether of bisphenol A or of an alkylene oxide adduct thereof, di- or poly-glycidyl ether of hydrogenated bisphenol A or of an alkylene oxide adduct thereof and novolac type epoxy resin. Herein, alkylene oxide includes such as ethylene oxide and propylene oxide.

An alicyclic epoxide is preferably a compound containing cyclohexene oxide or cyclopentene oxide obtained by epoxydizing a compound having at least one cycloalkane ring such as cyclohexene or cyclopentene by use of a suitable oxidizing agent such as hydrogen peroxide or a peracid.

A preferable aliphatic epoxide is such as di- or polyglycidyl ether of aliphatic polyhydric alcohol or of an alkylene oxide adduct thereof; the typical examples include diglycidyl ether of alkylene glycol, such as diglycidyl ether of ethylene glycol, diglycidyl ether of propylene glycol and diglycidyl ether of 1,6-hexane diol; polyglycidyl ether of polyhydric alcohol such as di- or triglycidyl ether of glycerin or of an alkylene oxide adduct thereof; and diglycidyl ether of polyalkylene glycol such as diglycidyl ether of polyethylene glycol or of an alkylene oxide adduct thereof and diglycidyl ether of polypropylene glycol or of an alkylene oxide adduct thereof. Herein, alkylene oxide includes such as ethylene oxide and propylene oxide.

Among these epoxides, aromatic epoxide and alicyclic epoxide are preferable and alicyclic epoxide is specifically preferable, taking a quick curing property in consideration. In the invention, one kind of epoxides described above alone may be utilized, and suitable combinations of two or more kinds thereof may also be utilized.

Examples of the vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butane diol divinyl ether, hexane diol divinyl ether, cyclohexane dimethanol divinyl ether, and trimethylol propane trivinyl ether; and mono vinyl ether compounds such as ethyl vinyl ether, n-butyl vinyl ether, iso-butyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether and octadecyl vinyl ether.

In these vinyl ether compounds, when the hardenability, adhesion or surface hardness is considered, di- or tri-vinyl ether compounds are preferable, and particularly divinyl ether compounds are preferable. In the present invention, these vinyl ether compounds may be used alone or as an admixture of two or more kinds thereof.

The oxetane compound refers to a compound having an oxetane ring, and in the invention, all the oxetane compounds can be used which are disclosed in Japanese Patent O.P.I. Publication Nos. 2001-220526 and 2001-310937. When an ink composition contains an oxetane compound having five or more oxetane rings, viscosity of the ink composition increases or glass transition point of the ink composition is elevated, which may result in difficulty to handling, and poor tackiness of cured ink composition. Therefore, an oxetane compound having 1 to 4 oxetane rings is preferred.

Next, the oxetane compound will be explained, but the invention is not limited thereto. As one example of an oxetane compound having one oxetane ring, an oxetane compound represented by the following formula 1 is cited.

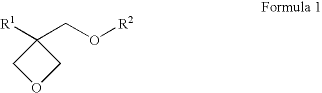

In formula 1, R¹ represents a hydrogen atom, an alkyl group having from 1 to 6 carbon atoms such as a methyl group, an ethyl group, a propyl group, a butyl group, etc.; a fluoroalkyl group having from 1 to 6 carbon atoms; an allyl group; an aryl group; a furyl group; or a thienyl group; and R² represents an alkyl group having from 1 to 6 carbon atoms such as a methyl group, an ethyl group, a propyl group, a butyl group, etc.; an alkenyl group having from 2 to 6 carbon atoms such as a 1-propenyl group, a 2-propenyl group, a 2-methyl-1-propenyl group, a 2-methyl-2-propenyl group, a 1-butenyl group, a 2-butenyl group, a 3-butenyl group, etc.), an aromatic ring-containing group such as a phenyl group, a benzyl group, a fluorobenzyl group, a methoxybenzyl group; a phenoxyethyl group, etc.; an alkylcarbonyl group having from 2 to 6 carbon atoms such as an ethylcarbonyl group, a propylcarbonyl group, a butylcarbonyl group, etc.; an alkoxycarbonyl group having from 2 to 6 carbon carbons such as an ethoxycarbonyl group, a propoxycarbonyl group, a butoxycarbonyl group, etc.; an N-alkylcarbamoyl group having from 2 to 6 carbon atoms such as an ethylcarbamoyl group, a propylcarbamoyl group, a butylcarbamoyl group, a pentylcarbamoyl, etc. The oxetane compound used in the invention is preferably a compound having one oxetane ring in that the composition containing such a compound is excellent in tackiness, low in viscosity, and is easy to handle.

As one example of an oxetane compound having two oxetane rings, an oxetane compound represented by the following formula 2 is cited.

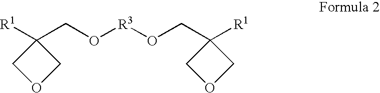

In formula 2, R¹ represents the same group as those denoted in R₁ in formula 1; and R³ represents a straight chained or branched alkylene group such as an ethylene group, a propylene group, a butylene group, etc.; a straight chained or branched polyalkyleneoxy group such as a poly(ethyleneoxy) group, a poly(propyleneoxy group, etc.; a straight chained or branched unsaturated divalent hydrocarbon group such a propenylene group, a methylpropenylene group, a butenylene group, etc.; an alkylene group containing a carbonyl group; an alkylene group containing a carbonyloxy group; or an alkylene group containing a carbamoyl group.

R³ also represents a divalent group selected from groups represented by the following formulae 3, 4, and 5.

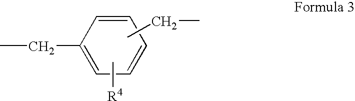

In formula 3, R⁴ represents a hydrogen atom, an alkyl group having from 1 to 4 carbon atoms such as a methyl group, an ethyl group, a propyl group, a butyl group, etc.; an alkoxy group having from 1 to 4 carbon atoms such as a methoxy group, an ethoxy group, a propoxy group, a butoxy group, etc.; a halogen atom such as a chlorine atom, a bromine atom, etc.; a nitro group; a cyano group; a mercapto group; a lower alkylcarboxy group; carboxyl group; or a carbamoyl group.

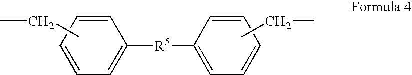

In formula 4, R⁵ represents an oxygen atom, a sulfur atom, a methylene group, —NH—, —SO—, —SO₂—, —(CF₃)₂—, or —C(CH₃)₂—.

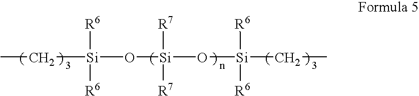

In formula 5, R⁶ represents an alkyl group having from 1 to 4 carbon atoms such as a methyl group, an ethyl group, a propyl group, a butyl group, etc., or an aryl group; “n” represents an integer of from 0 to 2000; and R⁷ represents an alkyl group having from 1 to 4 carbon atoms such as a methyl group, an ethyl group, a propyl group, a butyl group, etc, or an aryl group, or a group represented by the following formula 6.

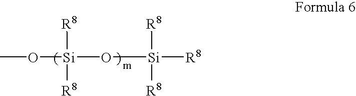

In formula 5, R⁸ represents an alkyl group having from 1 to 4 carbon atoms such as a methyl group, an ethyl group, a propyl group, a butyl group, etc., or an aryl group; and m represents an integer of from 0 to 100.

Examples of a compound having two oxetane rings include the following exemplified compounds 1 and 2.

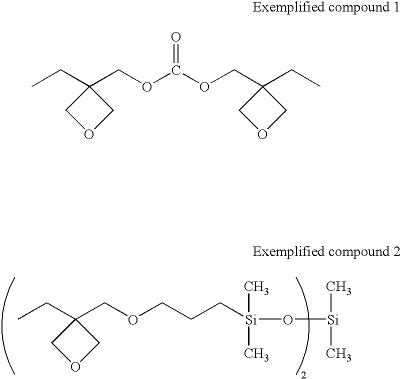

Exemplified compound 1 is a compound in which in formula 2, R¹ is an ethyl group, and R³ is a carbonyl group. Exemplified compound 2 is a compound in which in formula 2, R¹ is an ethyl group, and R³ is a group in which in formula 5, R⁶ is a methyl group, R⁷ is a methyl group, and n is 1.

As another example of an oxetane compound having two oxetane rings, an oxetane compound represented by the following formula 7 is cited. In formula 7, R¹ is the same as those denoted in R¹ of formula 1.

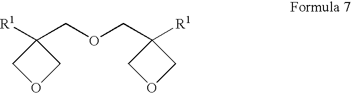

As an example of an oxetane compound having three or four oxetane rings, an oxetane compound represented by the following formula 8 is cited.

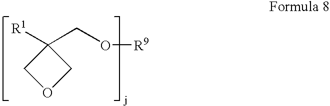

In formula 8, R¹ is the same as those denoted in R¹ of formula 1; and R⁹ represents a branched alkylene group having 1 to 12 carbon atoms such as a group represented by A, B, or C below, a branched polyalkyleneoxy group such as a group represented by D below, or a branched alkylene group containing a silylether group such as a group represented by E below.

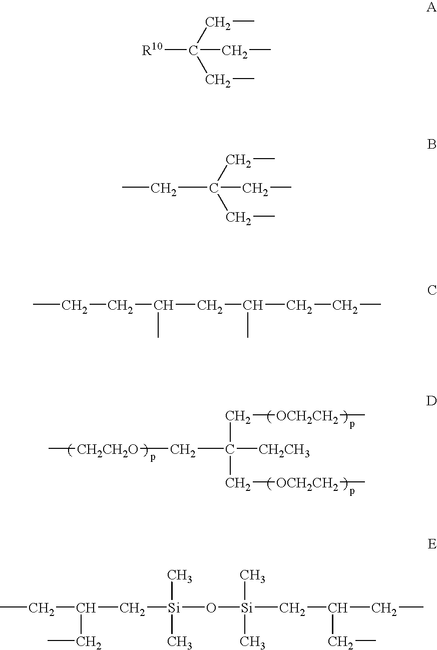

In formula A, R¹⁰ represents a lower alkyl group such as a methyl group, an ethyl group, or a propyl group. In formula D, n represents an integer of from 1 to 10.

As an example of an oxetane compound having four oxetane rings, an exemplified compound 3 is cited.

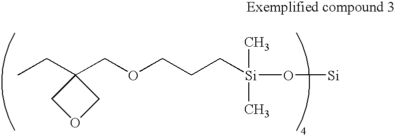

As a compound having 1 to 4 oxetane rings other than the compounds described above, a compound represented by the following formula 9 is cited.

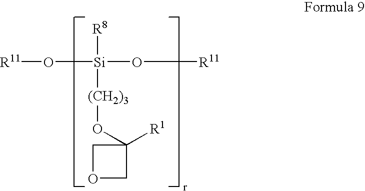

In formula 9, R⁸ is the same as those denoted in R⁸ of formula 6; R¹¹ represents an alkyl group having 1 to 4 carbon atoms such as a methyl group, an ethyl group, or a propyl group, or a trialkylsilyl group; r represents an integer of from 1 to 4; and R¹ is the same as those denoted in R¹ of formula 1.

The preferred oxetane compounds used in the invention are exemplified compounds 4, 5, 6 as shown below.

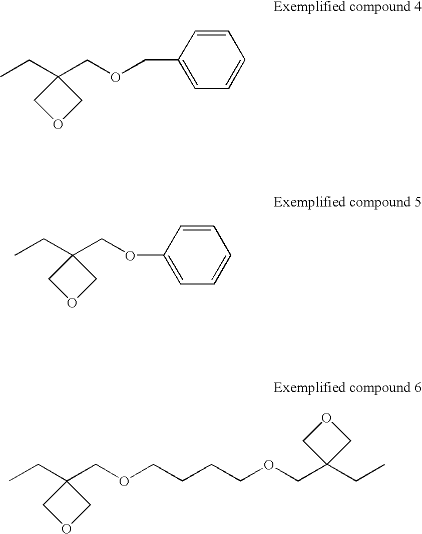

Synthetic method of the above-described oxetane compounds is not specifically limited, and known methods can be used. There is, for example, a method disclosed in D. B. Pattision, J. Am. Chem. Soc., 3455, 79 (1957) in which an oxetane ring is synthesized from diols.

Besides the above-described oxetane compounds, polymeric oxetane compounds having 1 to 4 oxetane rings with a molecular weight of 1000 to 5000 can be used. Examples thereof include the following compounds.

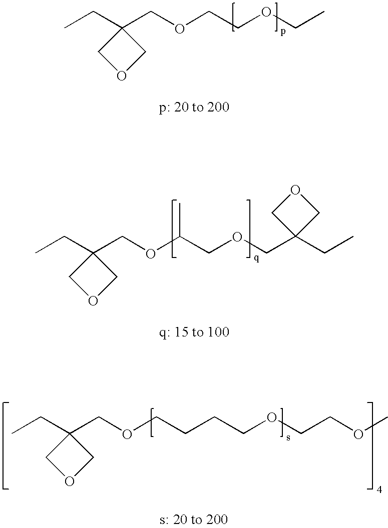

In the invention, in order to carry out curing reaction efficiently, the reaction is carried out in the presence of a photopolymerization initiator. With respect to the photopolymerization initiator, when a radical polymerizable compound is used, the photopolymerization initiator is a radical generator, and when a cation polymerizable compound is used, the photopolymerization initiator is a photo acid generator. As the radical generator, there are a bond opening type radical generator and a hydrogen withdrawing type radical generator.

The content of the cation polymerizable compound in ink is preferably from 1 to 97% by weight, and more preferably from 30 to 95% by weight.

Examples of a bond opening type radical generator include acetophenone compounds such as diethoxyacetophenone, 2-hydroxy-2-methyl-1-phenylpropane-1-one, benzyldimethylketal, 1-(4-propylphenyl)-2-hydroxy-2-methylpropane-1-one, 4-(2-hydroxyethoxy)phenyl (2-hydroxy-2-propyl) ketone, 1-hydroxycyclohexyl phenyl ketone, 2-methyl-2-morpholino(4-thiomethylphenyl)propane-1-one, and 2-benzyl-2-dimethylamino-1-(4-morpholinophenyl)butanone; benzoines such as benzoin, benzoin methyl ether, and benzoin isopropyl ether; acylphospine oxides such as 2,4,6-trimethylbenzoyldiphenylphosphine oxides; benzil; and methylphenylglyoxy ester.

Examples of a hydrogen withdrawing type radical generator include benzophenones such as benzophenone, methyl o-benzoylbenzoate, 4-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl)benzophenone, and 3,3′-dimethyl-4-methoxybenzophenone; thioxanthones such as 2-isopropylthioxanthone, 2,4-dimethylthioxanthone, 2,4-diethylthioxanthone, and 2,4-dichlorothioxanthone; aminobenzophenones such as michler's ketone and 4,4′-diethylaminobenzophenone; 10-butyl-2-chloroacridone; 2-ethylanthraquinone; 9.10-phenanthrenequinone; and camphorquinone. The radical generator content of the UV ray curable ink is preferably from 0.01 to 10.00% by weight.

As the photo acid generator, for example, compounds used in a chemical amplification type photo resist or in a light cation polymerizable composition are used (Organic electronics material seminar “Organic material for imaging” from Bunshin publishing house (1993), refer to page 187-192). Examples suitable for the present invention will be listed below.

Firstly, a B (C₆F₅)₄⁻, PF₆⁻, AsF₆⁻, SbF₆⁻, CF₃SO₃⁻ salt of an aromatic onium compound such as an aromatic diazonium, ammonium, iodonium, sulfonium, or phosphonium compound, can be listed.

Examples of the onium compounds used in the invention will be shown below.

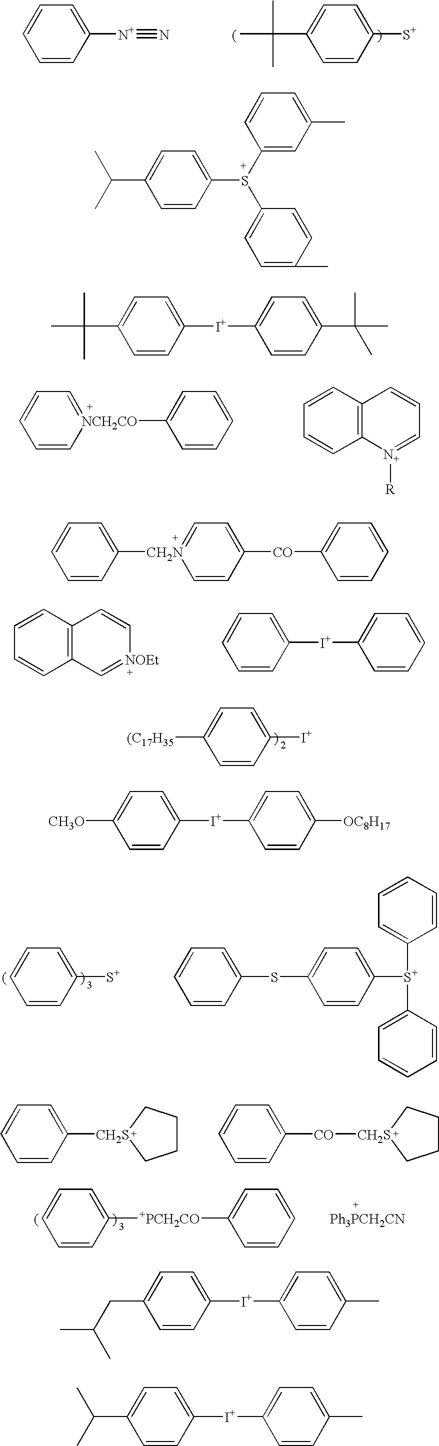

Secondly, sulfone compounds, which generate sulfonic acid, can be listed. Examples thereof will be shown below.

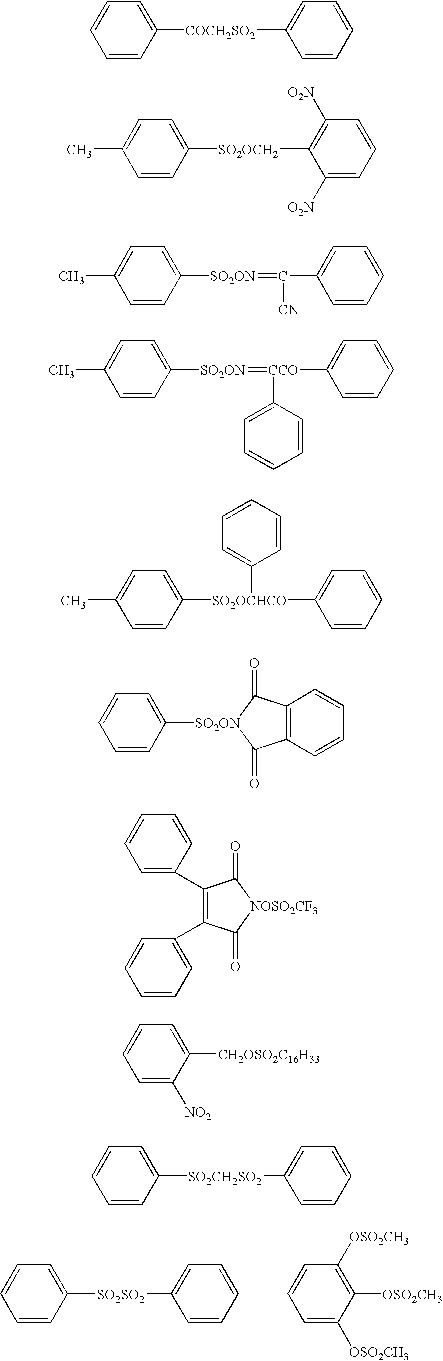

Thirdly, halide compounds, which generate hydrogen halide, can also be used. Examples thereof will be shown below.

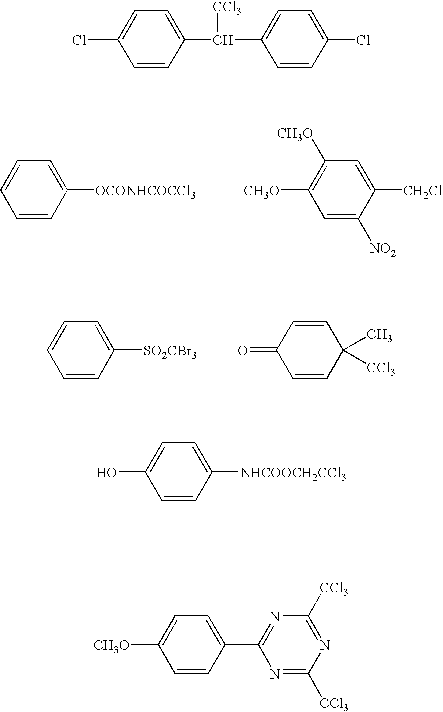

Fourthly, iron arene complexes, for example, those as described below can be listed.

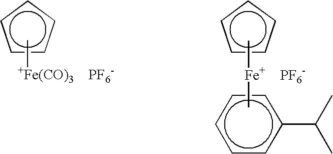

The UV ray curable ink of the invention is cured by UV irradiation. In order to carry out the curing reaction efficiently, a photosensitizer can be used. Examples of the photosensitizer include amines such as triethanolamine, metyldiethanolamine, triisopropanolamine, methyl 4-dimethylaminobenzoate, ethyl 4-dimethylaminobenzoate, isoamyl 4-dimethylaminobenzoate, 2-(dimethylamino)ethyl bonzoate, n-utoxyethyl 4-dimethylaminobonzoate, and 2-ethylhexyl 4-dimethylaminobonzoate; cyanine; phthalocyanine,; merocyanine; porphyrin; a spiro compound, ferrocene; fluorene; fulgide; imidazole; perylene; phenazine; phenothiazine; polyene; an azo compound, diphenylmethane; triphenylmethane; polymethine; acridine; cumarin; ketocumarien; quinacridone; indigo; styryl; a pyrylium compound; a pyrromethene compound; a pyrazolotriazole compound; a benzothiazole compound; a barbituric acid derivative; and a thiobarbituric acid derivative. Further, compounds are used which are disclosed in European Patent No. 568.993, U.S. Pat. Nos. 4,508,811 and 5,227,227, and Japanese Patent O.P.I. Publication Nos. 2001-125255 and 11-271969. The photosensitizer content of the UV ray curable ink is preferably from 0.01 to 10.00% by weight.

Preferred examples of pigments utilized in the invention will be listed below:

C.I. Pigment Yellow-1, 3, 12, 13, 14, 17, 74, 81, 83, 87, 95, 109, 42, 93, 120, 128, 138, 139, 151, 166, 180, 185

C.I. Pigment Orange-16, 36, 38

C.I. Pigment Red-5, 22, 38, 48:1, 48:2, 48:4, 49:1, 53:1, 57:1, 63:1, 144, 146, 185, 101, 122, 184, 202, 221, 254

C.I. Pigment Violet-19, 23

C.I. Pigment Blue-15:1, 15:3, 15:4, 4, 18, 60, 27, 29

C.I. Pigment Green-7, 36

C.I. Pigment White-6, 18, 21

C.I. Pigment Black-7

Further, in the invention, white ink is preferably utilized to increase a covering power of colors with transparent base materials such as a plastic film. It is preferable to utilize white ink, specifically in light package printing and label printing, however, due to increase of ejection amount, the using amount is naturally limited in respect to the above-mentioned ejection stability, and generation of curl and wrinkles of a recording material.

To disperse the above-described pigment, for example, a ball mill, a sand mill, an attritor mill, a roll mill, an agitator, a Henshel mixer, a colloidal mixer, a ultrasonic homogenizer, a pearl mill, a wet jet mill, a paint shaker, etc. can be utilized. Further, a dispersant can be added for dispersion of pigment.

Examples of the dispersant include carboxylic acid esters containing a hydroxyl group, salts of long chain polyaminoamides with high molecular weight acid esters, high molecular weight polycarboxylic acid salts, salts of long chain polyaminoamides with polar acid esters, high molecular weight unsaturated acid esters, high molecular copolymers, modified polyurethanes, modified polyacrylates, polyether ester type anion based surfactants, a salt of a naphthalenesulfonic acid formalin condensation product, a salt of an aromatic sulfonic acid formalin condensation product, polyoxyethylene alkylphosphoric acid esters, polyoxyethylene nonyl phenyl ether, stearylamine acetate, and pigment derivatives.

Typical examples of the dispersants include “Anti-Terra-U (a polyaminoamide phosphoric acid salt)”, “Anti-Terra-203/204 (a high molecular weight polycarboxylic acid salt)”, “Disperbyk-101 (polyaminoamide phosphoric acid salt and acid ester), 107 (a hydroxyl group containing carboxylic acid ester), 110 (an acid group containing copolymer), 130 (polyamide), 161, 162, 163, 164, 165, 166, and 170 (high molecular copolymer)”, “400”, “Bykumen” (a high molecular weight unsaturated acid ester), “BYK-P104, P105 (high molecular weight unsaturated polycarboxylic acid)” “P104S, 240S (high molecular weight unsaturated acid polycarboxylic acid and silicon based), and “Lactimon (long chain amine, unsaturated acid polycarboxylic acid, and silicon)”, manufactured by BYK Chemie Co.

Further, listed are “Efka 44, 46, 47, 48, 49, 54, 63, 64, 65, 66, 71, 701, 764, and 766”, “Efka Polymer 100 (modified polyacrylate), 150 (an aliphatic modified polymer), 400, 401, 402, 403, 450, 451, 452, and 453 (modified polyacrylates), 745 (being copper phthalocyanine based)”, manufactured by Efka Chemicals Co., and “Flowlen TG-710 (urethane oligomer)”, “Flownon SH-290, SP-1000”, “Polyflow No. 50E, and No. 300 (an acryl based copolymer)”, manufactured by Kyoei Kagaku Co., “Disparlon KS-860, 873SN, and 874 (a polymer dispersing agent), #2150 (aliphatic multivalent carboxylic acid), and #7004 (polyether ester type)”, manufactured by Kusumoto Kasei Co.

Further, listed are “Demol RN and N (both are naphthelenesulfonic acid formalin condensation product sodium salts), MS, C, and SN-B (all are aromatic sulfonic acid formalin condensation product sodium salts), and EP”, “Homogenol L-18 (a polycarboxylic acid type polymer)”, “Emulgen 920, 930, 931, 935, 950, and 985 (all are polyoxyethylene nonyl phenyl ethers)”, and “Acetamin 24 (coconut amine acetate) and 86 (stearylamine acetate)”, manufactured by Kao Corp., “Solsperse 5000 (phthalocyanine ammonium salt based), 13240 and 13940 (both are polyesteramine based), 17000 (being fatty acid amine based), 24000, 28000, and 32000”, manufactured by Zeneca Corp., “Nikkol T106 (polyoxyethylene sorbitan monooleate), MYS-IEX (polyoxyethylene monostearate), and Hexagline 4-0 (hexaglyceryl tetraoleate)”, manufactured by Nikko Chemical Co., and “Ajispar PB820”, manufactured by Ajinomoto Co., Ltd.

Of these dispersants, polymer dispersants are preferred since they can lower dependency of ink viscosity on the shear. The dispersant content of ink is preferably from from 0.1 to 10% percent by weight.

Further, as a dispersion aid, a synergist according to kinds of pigment can also be utilized. The dispersant and dispersion aid are preferably added in a range of from 1 to 50 weight parts based on 100 parts of a pigment. As a dispersion medium, a solvent or a polymerizable compound is utilized, however, the UV ray curable ink used of the invention is preferably an ink containing no solvent, since curing is carried out immediately after the ink has been deposited on recording material. When a solvent is left in the cured image, there cause problems of deterioration of resistance against solvents and VOC of residual solvent. Therefore, as a dispersion medium, not a solvent but a polymerizing compound, and a monomer having a lower viscosity among them is preferably selected, in respect to dispersion suitability.

In dispersion of a pigment, selection of a pigment, a dispersant and a dispersion medium, dispersion conditions and filtering conditions are suitably set so as to make a mean particle diameter of a pigment of preferably from 0.08 to 0.5 μm and the maximum particle diameter of from 0.3 to 10 μm and preferably from 0.3 to 3 μm. By this particle diameter control, it is possible to depress clogging of a head nozzle and maintain stability of ink, as well as transparency and curing sensitivity of ink.

The pigment content of the actinic ray curable ink of the invention is preferably from 1 to 10% by weight based on the total ink.

As a recording material used in the invention, ordinary non-coated paper or coated paper, or non-absorptive recording materials can be utilized. Among them, non-absorptive recording materials is preferred.

As the non-absorptive recording materials used in the invention, various non-absorptive plastics or their films can be used. Examples of the plastic films include, for example, a PET (polyethylene terephthalate) film, an OPS film, an OPP film, an ONy film, a PVC film, a PE film and a TAC film. Plastic films other than these, polycarbonate, acryl resin, ABS, polyacetal, PVA and a rubber series can be utilized. A metal series and a glass series are also applicable. Among these recording materials, effects of the invention become further effective especially in case of forming an image on a PET film, an OPS film, an OPP film, an ONy film and a PVC film, which are capable of thermal shrinking. These materials are liable to cause curl and deformation of film due to such as curing shrinkage or heat accompanied with curing reaction of ink, and, in addition, an ink layer is hard to follow shrinkage of the material.

Plastic films greatly differ in surface energy depending on the kinds, and heretofore, there has been a problem in that the ink dot diameter after ink deposition on recording material varies depending on the kinds of the recording materials. The recording materials used in the invention ranges from an OPP or OPS film each having a low surface energy to a PET film having a relatively high surface energy. In the invention, the recording materials have a surface energy of preferably from 40 to 60 mN/m.

Next, the image formation method of the invention will be explained.

The image formation method of the invention comprises the steps of ejecting the UV ray curable ink of the invention as ink droplets onto recording material, employing on-demand type ink jet nozzles, and irradiating UV rays to the ink ejected on the recording material to form an image, wherein the ink droplets comprise two or more separate ink droplets with a different volume.

The minimum volume of the ink droplets to be ejected is preferably less than 10 pl.

The image formation method of the invention can achieve ink jet recording providing excellent ejecting stability, accurate ink deposition onto recording material, and an ink-jet recording image with high precision.

(Ink ejection)

As conditions of ink ejection, ink ejection is preferably performed while an ink jet recording head and ink being heated at from 35 to 100° C. in respect to ejection stability. Since actinic ray curable ink shows a large viscosity variation width depending on temperature variation and which in turn significantly influences a liquid droplet size and a liquid droplet ejection speed resulting in deterioration of image quality, it is required to keep an ink temperature constant while raising the ink temperature. A control width of ink temperature is a set temperature ±5° C., preferably a set temperature ±2° C. and furthermore preferably a set temperature ±1° C.

An ink jet recording head used in the invention is a head employing a thermal method, a piezo method or a continuous method, and preferably a head employing a piezo method.

In the invention, a minimum droplet volume of the photo-curable ink ejected from nozzles of the ink jet recording head is preferably less than 10 μl, and more preferably from 2 to less than 10 μl. The droplet volume of the ink has to be in the range described above to form images with high resolution, however, this droplet volume tends to lower the aforementioned ejection stability. The ink jet recording head is preferably an ink jet recording head of multi-size droplet type capable of varying the ink droplet volume.

(UV ray irradiation)

As an actinic ray irradiation method, a basic method is disclosed in JP-A No. 60-132767, in which light sources are provided at the both sides of a head unit where a head and a light are scanned in a shuttle mode. Irradiation is performed in a certain time interval after ink has been ejected onto recording material. Further, curing is completed by another light source which is not driven. As a light irradiation method, a method utilizing optical fiber, and a method in which collimated light source is reflected by a mirror provided on the side surface of a head unit and UV ray (ultraviolet ray) is irradiated on a recording portion are disclosed in U.S. Pat. No. 6,145,979. In an image formation method of the invention, any of these irradiation methods can be utilized.

An ink jet recording apparatus (hereinafter also referred to as a recording apparatus) usable in the invention will be explained.

Next, the recording apparatus in the invention will be explained suitably in reference to a drawing. Herein, the recording apparatus of the drawing is one embodiment of a recording apparatus preferably used in the invention, and the invention is not limited to thereto.

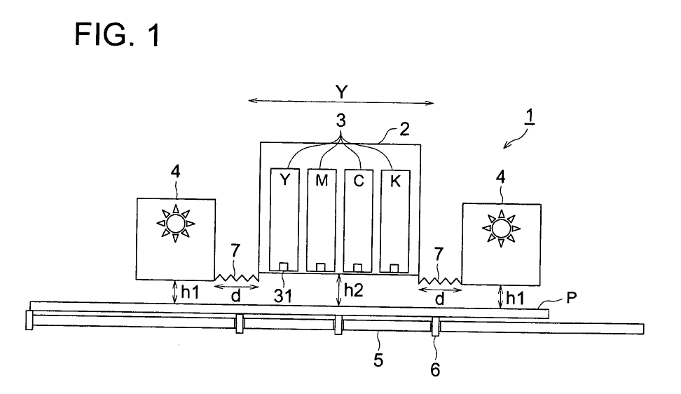

FIG. 1 is a front view illustrating one example of a main constitution of a recording apparatus in the invention employing a serial ink jet recording process. Recording apparatus 1 is equipped with head carriage 2, recording head 3, irradiation means 4 and platen portion 5. In recording apparatus 1, platen portion 5 is arranged under recording material P. Platen portion 5 has a UV ray absorbing function, and absorbs extra UV ray having passed through recording material P. As a result, images with high resolution can be reproduced quite stably.

Recording material P is guided by guide member 6 to be moved to the back side from the front side in FIG. 1 by operation of a transport means (not illustrated). Scan of recording head 3 held in head carriage 2 is made by reciprocating head carriage 2 in Y direction in FIG. 1 according to a head scanning means (not illustrated).

Head carriage 2 is provided over recording material P, and stores recording heads 3 described below with the ejection outlet 31 arranged downward, the number of recording heads 3 corresponding to the number of color inks used in an ink image printed on recording material. Head carriage 2 is provided in the main body of recording apparatus 1 so as to reciprocate in Y direction in FIG. 1 by a drive of a head scanning means.

Herein, FIG. 1 illustrates that head carriage 2 is supposed to store recording heads 3 of yellow (Y), magenta (M), cyan (C), black (K), however, the number of recording heads 3 stored in head carriage 2 in practical operation is suitably determined.

Recording head 3 ejects an actinic ray curable ink (for example, UV curable ink) to be supplied by means of an ink supplying means (not illustrated) from its ejection outlets onto recording material P by action of plural ejecting means (not illustrated) equipped in the recording apparatus. A UV ink to be ejected by recording head 3 is comprised of a colorant, a polymerizing monomer, an initiator, etc., and is cured by cross-linking and polymerization initiated by UV irradiation of an initiator as a catalyst.

Recording head 3 ejects UV ink as an ink droplet onto a pre-determined region (a region capable of receiving the ink) of recording material P while the scan of the head is made in which the head moves from one edge to another of the recording material in a Y direction in FIG. 1 by drive of the head scanning means, whereby the UV ink is deposited on that region of the recording material.

The above scan is suitably made several times to eject UV ink onto one region of recording material. After that, while the recording material P is transported from the front side to the back side in FIG. 1 by transport means and the scan of the recording head 3 is again made by the head scan means, UV ink is ejected from the recording head onto the next region of the back side in FIG. 1 of recording material, which is adjacent to the one region on which the UV ink has been ejected.

The above operation is repeated, whereby the UV ink is ejected from recording head 3 employing the head scan means and the transport means to form an image comprised of aggregates of UV ink droplets on recording material P.

Irradiation means 4 is equipped with a UV lamp which emits ultraviolet ray with a specific wavelength region at a stable exposure energy and a filter which transmits ultraviolet ray with a specific wavelength. Herein, Examples of the UV lamp include a mercury lamp, a metal halide lamp, an excimer laser, a UV laser, a cold cathode tube, a black light, and an LED, and a metal halide lamp tube, a cold cathode tube, a mercury lamp tube and a black light, having a band-shape, are preferable.

Irradiation means 4 has the possible largest size which can be installed in the recording apparatus 1 (an ink jet printer) or the irradiation region of the irradiation means 4 is larger than the largest region of recording material, onto which UV ink is ejected by one time scan of recording head 3 driven by a head scan means.

Irradiation means 4 is arranged by being fixed in nearly parallel with recording material 4 at the both sides of head carriage 2.

As described above, in order to adjust illuminance at an ink ejecting portion, it is natural to light-shield whole recording head 3, and, in addition, it is effective to make distance h2 between ink ejection outlet 31 of recording head 3 and recording material P longer than distance h1 between irradiation means 4 and recording material P (h1<h2) or to make distance d between recording head 3 and irradiation means 4 long (to make d large). Further, it is furthermore preferable to provide bellows structure 7 between recording head 3 and irradiation means 4.

Herein, wavelength of ultraviolet ray radiated through irradiation means 4 can be suitably changed by exchanging a UV lamp or a filter, which is installed in irradiation means 4.

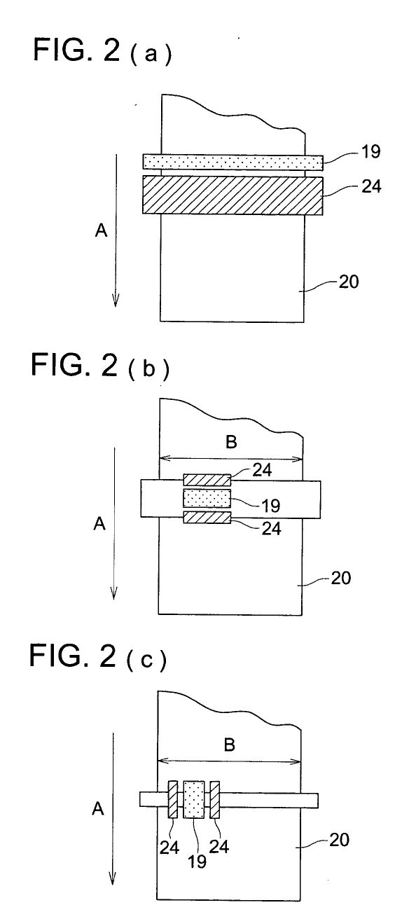

The recording apparatus described above, is a recording apparatus according to a serial ink jet recording process. The recording apparatuses employing various ink jet recording processes as shown in FIGS. 2(a), 2(b) and 2(c) can be used in the invention.

FIG. 2(a) shows a line head process, wherein an ink jet recording head 19 is arranged over recording material 20, and ink ejected from the head is deposited onto recording material 20 to be transported in the direction A (downward), and the deposited ink is exposed to actinic rays by means of irradiation means 24 to form a cured ink image.

FIG. 2(b) shows a flat head process, wherein ink ejected from the recording head 19 while the head is moving in the sub scanning direction B (rightward and leftward) is deposited onto recording material 20 to be transported in the direction A (downward), and the deposited ink is exposed to actinic rays by means of irradiation means 24 to form a cured ink image.

FIG. 2(c) shows a serial ink jet recording process, wherein ink ejected from the recording head 19 while the head is moving in a sub scanning direction B (rightward and leftward) is deposited onto recording material 20 to be transported in the direction A, and the deposited ink is exposed to actinic rays by means of irradiation means 24 provided on both sides of the head to form a cured ink image.

### EXAMPLES

The invention will be explained according to the following examples, however, the invention is not specifically limited thereto.

### Example 1

<<Preparation of ink-jet ink>>

Each of the following pigment compositions was dispersed in a sand grinder for 4 hours, employing zirconia beads, and further dispersed in an ultrasonic disperser for 10 minutes to obtain yellow, magenta, cyan, and black pigment dispersions.

| <Composition of yellow pigment dispersion> | |
|---|---|
| PY180 (Yellow HG AF LP901, | 2.5 parts by weight |
| produced by Clariant Co., Ltd.) | |
| Aron oxetane OXT221 | 70 parts by weight |
| (produced by Toa Gosei Co., Ltd.) | |
| Celloxide 2021P | 30 parts by weight |
| (produced by Daicell Co., Ltd.) | |
| Dispersant Solsperse 24000 | 0.5 parts by weight |
| (produced by Avecia Co., Ltd.) | |
| <Composition of magenta pigment dispersion> | |
| PR 202 (Quindo Magenta RV 6883B, | 2.5 parts by weight |
| produced by Bayer Co., Ltd.) | |
| Aron oxetane OXT221 | 70 parts by weight |
| (produced by Toa Gosei Co., Ltd.) | |
| Celloxide 2021P | 30 parts by weight |
| (produced by Daicell Co., Ltd.) | |
| Dispersant Solsperse 24000 | 0.375 parts by weight |
| (produced by Avecia Co., Ltd.) | |
| <Composition of cyan pigment dispersion> | |
| PB 15:4 | 2.5 parts by weight |
| (produced by Dainichi Seka Co., Ltd.) | |
| Aron oxetane OXT221 | 70 parts by weight |
| (produced by Toa Gosei Co., Ltd.) | |
| Celloxide 2021P | 30 parts by weight |
| (produced by Daicell Co., Ltd.) | |
| Dispersant Solsperse 24000 | 0.375 parts by weight |
| (produced by Avecia Co., Ltd.) | |
| <Composition of black pigment dispersion> | |
| Carbon black (MA7, produced | 2.5 parts by weight |
| by Mitsubishi Kagaku Co., Ltd.) | |
| Aron oxetane OXT221 | 70 parts by weight |
| (produced by Toa Gosei Co., Ltd.) | |
| Celloxide 2021P | 30 parts by weight |
| (produced by Daicell Co., Ltd.) | |
| Dispersant Solsperse 24000 | 0.375 parts by weight |
| (produced by Avecia Co., Ltd.) | |

Subsequently, 5 parts by weight of photopolymerization initiator (SP152 produced by Asahi Denka Co., Ltd.) was added to the pigment dispersion obtained above based on 100 parts by weight of the pigment dispersion, mixed, and filtered through a membrane filter with a pore diameter of 0.8 μm. The resulting filtrate was dewatered at 50° C. under reduced pressure. Thus, yellow, magenta, cyan and black inks for ink-jet recording were obtained.

The viscosity and surface tension of the polymerizable compound and the resulting inks are shown in Table 1. The viscosity was measured through MCR 300 produced by Physica Co., Ltd.

TABLE 1

| | Viscosity at 25° C. | | | |
|---|---|---|---|---|
| | (mPa · s) | | | surface |
| | at shear | at shear | ¹⁾ Viscosity | tension |
| | rate of 10 | rate of 1000 | difference | at 25° C. |
| | (1/s) | (1/s) | (mPa · s) | (mN/m) |
| Yellow ink | 32.1 (8.2)* | 28.7 | 3.4 | 34.7 |
| Magenta ink | 29.7 (5.8)* | 26.3 | 3.4 | 34.7 |
| Cyan ink | 25.3 (1.4)* | 24.7 | 0.6 | 34.8 |
| Black ink | 27.7 (3.8)* | 27.1 | 0.6 | 34.8 |
| ²⁾ Polymeri- | 23.9 | 23.3 | 3.4 | 34.8 |
| zable | | | | |
| compound | | | | |

¹⁾ Viscosity difference represents a viscosity difference between a viscosity at 25° C. at shear rate 10 (1/s) and a viscosity at 25° C. at shear rate 1000 (1/s)
²⁾ Polymerizable compound: Aronoxetane OXT221/Celloxide 2021P = 70/30 (parts by weight)
*The value in the parenthesis represents a viscosity difference at shear rate 10 (1/s) between the ink and the polymerizable compound.

The resulting ink-jet ink was ejected employing a piezo type ink-jet nozzle according to a super drop process ejecting ink droplets with a minimum volume of 7 pl (one droplet (7 pl)/drop, two droplets (14 pl)/drop) at a drive frequency of 10 kHz, and the temperature of the ink and ink supply head having been controlled to be 50° C. The ink was ejected as two ink droplets comprised of a first droplet and a second droplet ejected in that order, and deposited onto recording material as one ink drop comprised of the two ink droplets (with a total ink droplet volume of 14 pl). The ejecting speed of the second droplet was measured at tenth drop and at one hundredth drop. Further, after ten hour continuous ejection of the ink, ejection straightness was evaluated according to the following criteria.

A: Ejection angle difference was not more than 1.5° at all the ink channels.

B: Ejection angle difference was from more than 1.50 to less than 2° at some ink channels.

C: Ejection angle difference was not less than 20 at some ink channels.

The ejection angle difference is an ejection angle deviation of ink ejection direction from the direction parallel to the ink channels, and is measured from a microscopic photograph of the ink ejection.

The results are shown in Table 2.

TABLE 2

| | | | Ink ejecting |
|---|---|---|---|
| | | | straightness |
| | | At one | after ten hour |
| | At tenth ink | hundredth ink | continuous ink |
| Ink | drop | drop | ejection |
| Yellow ink | 5.6 m/s | 5.9 m/s | A |
| Magenta ink | 5.7 m/s | 5.9 m/s | A |
| Cyan ink | 5.9 m/s | 6.0 m/s | A |
| Black ink | 5.9 m/s | 6.0 m/s | A |

As is apparent from Table 2, all the inks are low in fluctuation of ink ejecting speed and excellent in ink ejecting straightness.

Comparative magenta ink was prepared in the same manner as in magenta ink above, except that the following comparative magenta composition was used. The viscosity and surface tension of the comparative ink are shown in Table 3. Evaluation results are shown in Table 4.

<Comparative magenta composition>

| | |
|---|---|
| PR 146 (Seikafast fastcarmin 3870B, produced | 2.5 parts by weight |
| by Dainichi Seika Co., Ltd.) | |
| Aronoxetane OXT221 | 70 parts by weight |
| (produced by Toa Gosei Co., Ltd.) | |
| Celloxide 2021P | 30 parts by weight |
| (produced by Daicell Co., Ltd.) | |
| Dispersant Solsperse 24000 | 0.375 parts by weight |
| (produced by Avecia Co., Ltd.) | |

TABLE 3

| | Viscosity at 25° C. | | | |
|---|---|---|---|---|
| | (mPa · s) | | | Surface |
| | At shear | At shear | Viscosity | tension |
| | rate of 10 | rate of 1000 | difference | at 25° C. |
| Ink | (1/s) | (1/s) | (mPa · s) | (mN/m) |
| Magenta ink | 38.3 | 29.0 | 9.3 | 34.7 |
| (Comparative) | | | | |

TABLE 4

| | | | Ink ejecting |
|---|---|---|---|
| | | | straightness |
| | | At one | after ten hour |
| | At tenth ink | hundredth ink | continuous ink |
| Ink | drop | drop | ejection |
| Magenta ink | 4.7 m/s | 5.9 m/s | C |
| (comparative) | | | |

As is apparent from Table 3, the comparative magenta ink has a large viscosity difference between a viscosity at 25° C. at shear rate 10 (1/s) and a viscosity at 25° C. at shear rate 1000 (1/s), and as is apparent from Table 4, the comparative magenta ink shows poor ink ejecting straightness.

### EFFECTS OF THE INVENTION

The UV ray curable ink of the invention can achieve ink jet recording providing excellent ejecting stability, accurate ink deposition onto recording material, and an ink-jet recording image with high precision.

What is claimed is:

1. A UV ray curable ink comprising pigment, a polymerizable compound, and a photopolymerization initiator, wherein the UV ray curable ink has an absolute value of a viscosity difference between a viscosity at 25° C. at shear rate 10 (1/s) and a viscosity at 25° C. at shear rate 1000 (1/s) being not more than 5 mPa·s, and has a surface tension at 25° C. of from 26 to 38 mN/m.

2. The UV ray curable ink of claim 1, wherein the absolute value of a viscosity difference in viscosity at 25° C. at shear rate 10 (1/s) between the ink and the polymerizable compound is not more than 10 mPa·s.

3. The UV ray curable ink of claim 1, wherein the absolute value of a viscosity difference between a viscosity at 25° C. at shear rate 10 (1/s) and a viscosity at 25° C. at shear rate 1000 (1/s) is not more than 2 mPa·s.

4. The UV ray curable ink of claim 1, wherein the surface tension at 25° C. is from 28 to 35 mN/m.

5. The UV ray curable ink of claim 2, wherein the absolute value of a viscosity difference in viscosity at 25° C. at shear rate 10 (1/s) between the ink and the polymerizable compound is not more than 5 mPa·s.

6. The UV ray curable ink of claim 1, wherein the polymerizable compound is a cation polymerizable compound.

7. The UV ray curable ink of claim 6, wherein the cation polymerizable compound is comprised of an oxetane compound and at least one of an epoxy compound and a vinyl ether compound.

8. The UV ray curable ink of claim 7, wherein the oxetane compound has from one to four oxetane rings in the molecule.

9. The UV ray curable ink of claim 8, wherein the oxetane compound having one oxetane ring in the molecule is a compound represented by the following formula 1, 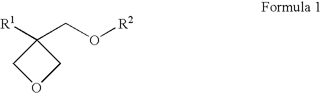
wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; and R² represents an alkyl group having from 1 to 6 carbon atoms, an alkenyl group having from 2 to 6 carbon atoms, an aromatic ring-containing group, an alkylcarbonyl group having from 2 to 6 carbon atoms, an alkoxycarbonyl group having from 2 to 6 carbon carbons, or an N-alkylcarbamoyl group having from 2 to 6 carbon atoms.

10. The UV ray curable ink of claim 8, wherein the oxetane compound having two oxetane rings in the molecule is a compound represented by the following formula 2, 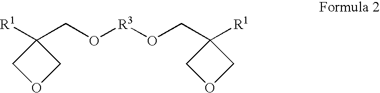
wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; and R³ represents a straight chained or branched alkylene group, a straight chained or branched polyalkyleneoxy group, a straight chained or branched divalent unsaturated hydrocarbon group, an alkylene group containing a carbonyl group, an alkylene group containing a carbonyloxy group, or an alkylene group containing a carbamoyl group.

11. The UV ray curable ink of claim 8, wherein the oxetane compound having two oxetane rings in the molecule is a compound represented by the following formula 7, 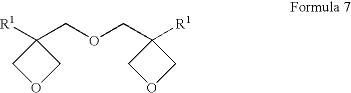
wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group.

12. The UV ray curable ink of claim 8, wherein the oxetane compound having tree or four oxetane rings in the molecule is a compound represented by the following formula 8, 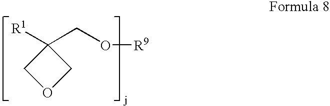
wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; R⁹ represents a branched alkylene group having 1 to 12 carbon atoms, a branched polyalkyleneoxy group, or a branched alkylene group containing a silylether group; and j represents an integer of 3 or 4.

13. The UV ray curable ink of claim 8, wherein the oxetane compound having from one to four oxetane rings in the molecule is a compound represented by the following formula 9, 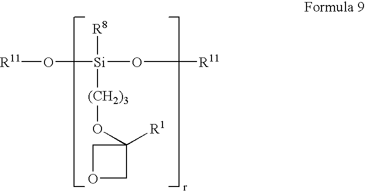
wherein R¹ represents a hydrogen atom, an alkyl group having from 1 to 6 carbon atoms, a fluoroalkyl group having from 1 to 6 carbon atoms, an allyl group, an aryl group, a furyl group or a thienyl group; R⁸ represents an alkyl group having from 1 to 4 carbon atoms or an aryl group; R¹¹ represents an alkyl group having 1 to 4 carbon atoms or a trialkylsilyl group; and r represents an integer of from 1 to 4.

14. The UV ray curable ink of claim 6, wherein the cation polymerizable compound content of the ink is from 1 to 97% by weight based on the weight of the ink.

15. The UV ray curable ink of claim 14, wherein the cation polymerizable compound content of the ink is from 30 to 95% by weight based on the weight of the ink.

16. The UV ray curable ink of claim 1, wherein the polymerizable compound is a radical polymerizable compound.

17. The UV ray curable ink of claim 16, wherein the radical polymerizable compound content of the ink is from 1 to 97% by weight based on the weight of the ink.

18. The UV ray curable ink of claim 17, wherein the radical polymerizable compound content of the ink is from 30 to 95% by weight based on the weight of the ink.

19. An image formation method comprising the steps of ejecting the UV ray curable ink of claim 1 as ink droplets onto recording material, employing on-demand type ink jet nozzles; and
irradiating UV rays to the ink ejected on the recording material to form an image, wherein the ink droplets comprise two or more separate droplets with a different volume.

20. The image formation method of claim 19, wherein the minimum volume of the ink droplets is less than 10 pl.
